(19) United States
(12) Patent Application Publication
(10) Pub. No.: US 2018/0092372 A1
(43) Pub. Date: Apr. 5, 2018

(54) METHODS AND APPARATUSES FOR PRODUCING LACTOSE REDUCED MILK

(71) Applicant: Tetra Laval Holdings & Finance S.A., Pully (CH)

(72) Inventor: Karsten LAURITZEN, Galten (DK)

(21) Appl. No.: 15/554,023

(22) PCT Filed: Mar. 10, 2016
(86) PCT No.: PCT/EP2016/055121

§ 371 Date: Aug. 28, 2017

(30) Foreign Application Priority Data
Mar. 17, 2015 (SE) 1550320-4

(51) Int. Cl. A23C 9/142

(52) U.S. Cl. CPC A23C 9/1422; A23C 2210/206

(57) ABSTRACT

It is presented a method for producing a lactose reduced milk product. The method comprises feeding milk through a microfiltration (MF) device to obtain a MF permeate and a MF retentate, feeding said MF permeate through an ultrafiltration (UF) device to obtain an UF permeate and an UF retentate, feeding said UF retentate through a nanofiltration (NF) device to obtain a NF permeate and a NF retentate, combining said NF permeate with said MF retentate into said lactose reduced milk product, and hydrolyzing said lactose reduced milk product to further reduce lactose content of said lactose reduced milk product.

### TECHNICAL FIELD

Methods and apparatuses related to the field of production of lactose reduced milk are presented. More particularly, the methods and apparatuses are related to a number of filtration steps and filtration devices, respectively, used in order to obtain lactose reduced, even substantially lactose free, milk products.

### BACKGROUND OF THE INVENTION

The last decades the number of people suffering from lactose intolerance has steadily increased, and as a direct effect the demand for lactose reduced milk products has increased. This in turn has raised interest from food producers, in particular dairies, to find processing equipment capable of producing milk products containing as little lactose as possible, but still with similar properties as ordinary dairy products, in a cost efficient and reliable way.

It has been found that by using a combination of different filters the lactose content of milk can be reduced to very low levels. One example of such a process is described in WO 2009/043356 by Arla Foods Amba. In this process the lactose content of skim milk can be reduced to as low levels as 0.01% compared to about 4.8% in ordinary skim milk.

The process of WO2009/043356 comprises an ultra filtration step in which a first permeate and a first retentate are formed. The first permeate is then fed to a nano filtration step in which a second permeate and a second retentate are formed. Next the first retentate and the second permeate are mixed and later hydrolyzed.

When using this process above a side effect is that the protein and the calcium content of the resulting product will differ from the input milk, and thus the resulting product will have slightly different properties compared to the input milk. In order to be able to offer a milk with calcium and protein content similar to milk there is a need from food producers for systems and methods capable of producing lactose free milk products with calcium and protein content similar to milk.

### SUMMARY

Accordingly, the methods and apparatuses described herein preferably seeks to mitigate, alleviate or eliminate one or more of the above-identified deficiencies in the art and disadvantages singly or in any combination and solves at least the above mentioned problems.

According to a first aspect it is provided a method for producing a lactose reduced milk product, said method comprising feeding milk through a microfiltration (MF) device to obtain a MF permeate and a MF retentate, feeding said MF permeate through an ultrafiltration (UF) device to obtain an UF permeate and an UF retentate, feeding said UF retentate through a nanofiltration (NF) device to obtain a NF permeate and a NF retentate, combining said NF permeate with said MF retentate into said lactose reduced milk product, and hydrolyzing said lactose reduced milk product to further reduce lactose content of said lactose reduced milk product.

The method may further comprise feeding said UF permeate to said MF device in order to use said UF permeate as a diafiltration media.

The milk when being fed through said MF device, said UF device or said NF device may have a temperature in the range of 5 to 60 degrees C., preferably 5 to 15 degrees C., even more preferably 8 to 12 degrees C.

Mesh sizes of said MF device, said UF device and said NF device may be chosen such that a resulting ratio of protein to calcium is substantially the same as a ratio of protein to Calcium in said milk.

According to a second aspect it is provided a system for producing a lactose reduced milk product, said system comprising a MF device arranged to receive milk and to form a MF permeate and a MF retentate, an UF device arranged to receive said MF permeate and to form an UF permeate and an UF retentate, a NF device arranged to receive an UF permeate and to form a NF permeate and a NF retentate, a flow combining device arranged to combine said NF permeate and said MF retentate into said lactose reduced milk, and a hydrolyzing tank arranged to hydrolyze said lactose reduced milk product to further reduce lactose content of said lactose reduced milk product.

The UF permeate may be fed to said MF device in order to use said UF permeate as a diafiltration media in said MF device.

The milk when being fed through said MF device, said UF device or said NF device may have a temperature in the range of 5 to 60 degrees C., preferably 5 to 15 degrees C., even more preferably 8 to 12 degrees C.

Mesh sizes of said MF device, said UF device and said NF device may be chosen such that a resulting ratio of protein to Calcium is substantially the same as a ratio of protein to calcium in said milk.

The mesh sizes of said MF may be approximately 0.1 μm and/or said UF device may comprise 5 or 10 kD membranes and/or said NF device may comprise 150-300 kD membranes.

According to a third aspect it is provided a lactose reduced milk product produced according to the method according to the first aspect.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 illustrates a flow chart of a system for producing lactose reduced milk according to a prior art solution disclosed in WO2009/043356.

FIG. 2 illustrates a flow chart of a system for producing lactose reduced milk, wherein the calcium and protein content of the resulting product is similar to the input milk.

### DETAILED DESCRIPTION OF PREFERRED EMBODIMENTS

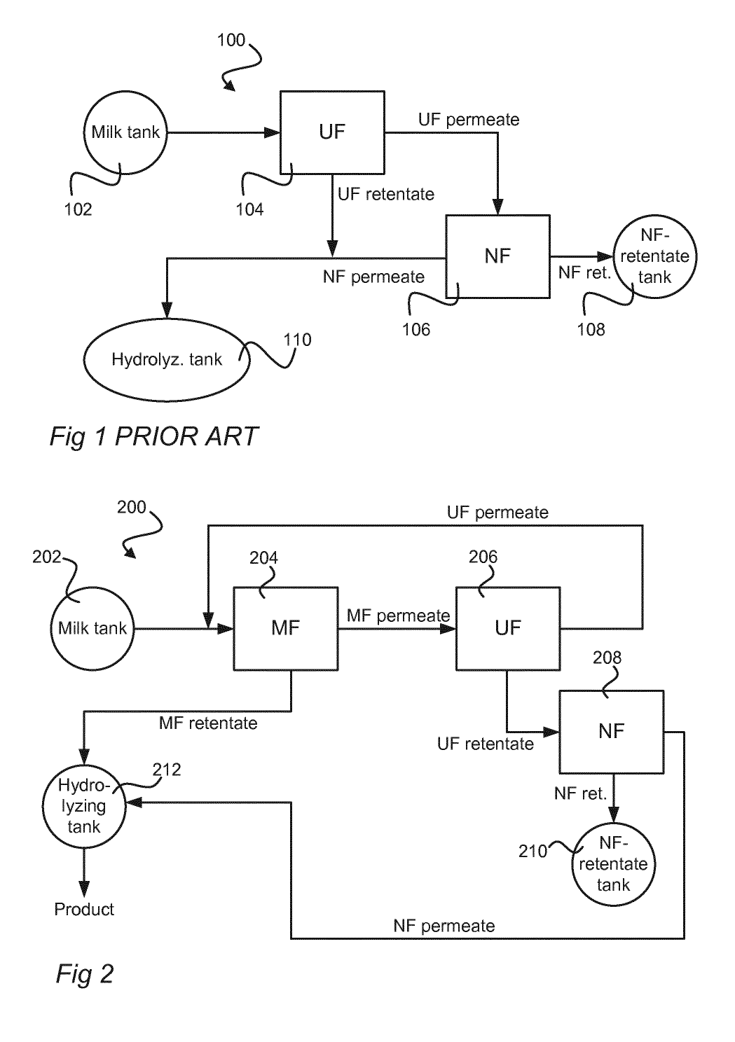

In FIG. 1, a system 100 for producing lactose reduced milk according to a continuous process disclosed in WO2009/043356, also mentioned above, is illustrated.

Skim milk held in a milk tank 102 is fed to an ultra filtration (UF) device 104 in which an UF permeate and an UF retentate are formed. The UF permeate is fed to a nano filtration (NF) device 106 in which a NF permeate and a NF retentate are formed. The NF retentate is fed and stored in a NF retentate tank 108, while the NF permeate is mixed with the UF retentate, formed in the UF device 104, and fed to a hydrolyzing tank 110.

As mentioned in the background section, a side effect of the process is that the protein content will be increased. This is largely dependent on that proteins are enriched in the UF device 104. More particularly, in the UF device proteins are concentrated, which means that the UF retentate will have a higher protein content than the skim milk and correspondingly that the UF permeate will have a lower protein content.

After having fed the UF permeate to the NF device 106 the NF retentate is formed and fed to the NF retentate tank 108, while the NF permeate formed in the NF device 106 is mixed with UF retentate. When subjecting the UF permeate to nanofiltration, lactose is sorted to the NF retentate which then can be sorted to a separate tank, herein the NF retentate tank. Thus, in summary, by using ultrafiltration proteins, that are molecules larger than the lactose molecules, mineral molecules and water molecules, can be sorted out. Next, the remaining lactose, mineral and water molecules are subjected to a nanofilter such that the lactose molecules, that are larger than mineral and water molecules, can be sorted out. Finally, the proteins and the minerals and water can be combined into a lactose reduced milk product.

An effect of sorting out the proteins at an early stage and then adding them again in a final stage is that few proteins are lost during the process, which has the effect that the ratio protein to calcium will not be the same as in original skim milk. This in turn will affect the product properties such that these are not the same as original skim milk.

In FIG. 2 an example of a system 200 for producing lactose reduced milk is illustrated. In this particular example, milk from a milk tank 202 is fed to a MF device 204 for forming an MF permeate and an MF retentate. The MF permeate is transferred to an UF device 206 in which an UF permeate and an UF retentate are formed. The UF permeate can be fed back to the MF device and be used as a diafiltration media. By doing so proteins that are not captured in the MF device 204, but captured in the UF device 206 are not fed back to the MF device once again.

The UF retentate is in a next step transferred to a NF device 208 for filtering out lactose. The filtered out lactose comprised in an NF retentate can be transferred to a NF retentate tank 210. The NF permeate, comprising inter alia water and minerals, is fed to a hydrolyzing tank 212. The MF retentate, comprising proteins, is also fed to the hydrolyzing tank 212.

In the hydrolyzing tank 212 the NF permeate and MF retentate combination is hydrolyzed such that any remaining lactose is split into glucose and galactose, which will reduce the level of lactose to a very low level, as low as below 0.05%.

An advantage of having the MF device 204 combined with the UF device 206 is that whey proteins and the dissolved calcium, being smaller than casein, can be filtered out by the MF device 204. The whey proteins will be captured by the UF device 206, but the calcium will not and is then fed back to the MF device 204. The whey proteins will also captured by the NF device 208 together with residuals of calcium and end up in the NF retentate tank 210 together with the lactose. The NF permeate comprising monovalent salts and water will be filtered out by the NF device 208 and fed to the hydrolyzing tank 212 to standardize the protein and lactose level prior to hydrolyzation.

| | Milk | Hydrolyzate | NF retentate |
|---|---|---|---|
| Mass [kg/h] | 10000 | 8960 | 1040 |
| TOP [g/100 g] | 3.42 | 3.42 | 3.34 |
| LAC [g/100 g] | 4.76 | <0.05 | 25.29 |
| Calcium | 120 | 118 | 137 |
| [mg/100 g] | | | |
| Fat [g/100 g] | 0.05 | 0.06 | 0.00 |
| TS [g/100 g] | 9.01 | 6.64 | 29.44 |

In the table above a test run of the system 200 in FIG. 2 is disclosed. As can be seen the protein content is the same in the hydrolyzate, i.e. the lactose reduced milk product, and the lactose is below 0.05%. The calcium level is about the same, and so is the fat content.

The invention has mainly been described above with reference to a few embodiments. However, as is readily appreciated by a person skilled in the art, other embodiments than the ones disclosed above are equally possible within the scope of the invention, as defined by the appended patent claims.

1. A method for producing a lactose reduced milk product, said method comprising
feeding milk through a microfiltration (MF) device to obtain a MF permeate and a MF retentate,
feeding said MF permeate through an ultrafiltration (UF) device to obtain an UF permeate and an UF retentate,
feeding said UF retentate through a nanofiltration (NF) device to obtain a NF permeate and a NF retentate,
combining said NF permeate with said MF retentate into said lactose reduced milk product, and
hydrolyzing said lactose reduced milk product to further reduce lactose content of said lactose reduced milk product.

2. The method according to claim 1, further comprising
feeding said UF permeate to said MF device in order to use said UF permerate as a diafiltration media.

3. The method according to claim 1, wherein said milk when being fed through said MF device, said UF device or said NF device has a temperature in the range of 5 to 60 degrees C., preferably 5 to 15 degrees C., even more preferably 8 to 12 degrees C.

4. The method according to claim 1, wherein mesh sizes of said MF device, said UF device and said NF device are chosen such that a resulting ratio of protein to Calcium is substantially the same as a ratio of protein to Calcium in said milk.

5. A system for producing a lactose reduced milk product, said system comprising
a MF device arranged to receive milk and to form a MF permeate and a MF retentate,
an UF device arranged to receive said MF permeate and to form an UF permeate and an UF retentate,
a NF device arranged to receive an UF retentate and to form a NF permeate and a NF retentate,
a flow combining device arranged to combine said NF permeate and said MF retentate into said lactose reduced milk, and
a hydrolyzing tank arranged to hydrolyze said lactose reduced milk product to further reduce lactose content of said lactose reduced milk product.

6. The system according to claim 5, wherein said UF permeate is fed to said MF device in order to use said UF permeate as a diafiltration media in said MF device.

7. The system according to claim 5, wherein said milk when being fed through said MF device, said UF device or said NF device has a temperature in the range of 5 to 60 degrees C., preferably 5 to 15 degrees C., even more preferably 8 to 12 degrees C.

8. The system according to claim 5, wherein mesh sizes of said MF device, said UF device and said NF device are chosen such that a resulting ratio of protein to Calcium is substantially the same as a ratio of protein to Calcium in said milk.

9. The system according to claim 5, wherein said mesh sizes of said MF is approximately 0.1 μm and/or said UF device comprises 5 or 10 kD membranes and/or said NF device comprises 150-300 kD membranes.

10. A lactose reduced milk product produced according to the method according to claim 1.
